(19) United States
(12) Patent Application Publication
(10) Pub. No.: US 2026/0341833 A1
(43) Pub. Date: Oct. 29, 2026

(54) TEMPERATURE-EQUALIZING PLATE AND BATTERY PACK

(71) Applicant: EVE ENERGY STORAGE CO., LTD, Wuhan (CN)

(72) Inventors: Zhonghui YU, Wuhan (CN); Pengyu WANG, Wuhan (CN); Yuli LIAO, Wuhan (CN); Chaojun FENG, Wuhan (CN); Yanqiu PENG, Wuhan (CN); Muhong GONG, Wuhan (CN); Yuan ZHU, Wuhan (CN)

(73) Assignee: EVE ENERGY STORAGE CO., LTD, Wuhan (CN)

(21) Appl. No.: 19/681,032

(22) Filed: May 18, 2026

Related U.S. Application Data
(63) Continuation of application No. PCT/CN2024/138110, filed on Dec. 10, 2024.

(30) Foreign Application Priority Data
Oct. 23, 2024 (CN) 202422572590.7

(51) Int. Cl. H01M 10/6554; H01M 10/613; H01M 10/653; H01M 10/6567

(52) U.S. Cl. CPC H01M 10/6554; H01M 10/613; H01M 10/653; H01M 10/6567

(57) ABSTRACT

A temperature-equalizing plate and a battery pack are provided. The temperature-equalizing plate includes a first heat-conducting layer, a second heat-conducting layer, and a third heat-conducting layer. The first heat-conducting layer includes a first surface and a second surface opposite to each other in a first direction. The second heat-conducting layer includes a third surface and a fourth surface opposite to each other in the first direction. The third heat-conducting layer is disposed between the first heat-conducting layer and the second heat-conducting layer in the first direction, and includes a fifth surface, a sixth surface, a seventh surface, and an eighth surface connected in turn, the fifth surface being in abutment with the second surface and the seventh surface being in abutment with the fourth surface.

### CROSS-REFERENCE TO RELATED APPLICATIONS

This application is a U.S. bypass continuation of International Patent Application No. PCT/CN2024/138110, filed on Dec. 10, 2024, which claims priority to Chinese Patent Application No. 202422572590.7, filed on Oct. 23, 2024. The entire contents of each of the above-referenced applications are expressly incorporated herein by reference.

### TECHNICAL FIELD

The present disclosure generally relates to batteries, and more particularly relates to a temperature-equalizing plate and a battery pack.

### BACKGROUND

Currently, temperature-equalizing plates that are commercially applied on a large scale adopt an internal vacuum microcavity structure designed along a length direction or a thickness direction. A temperature-equalizing plate of heat transfer design along the length direction has excellent heat-conducting performance in the length direction; however, the heat-conducting effect in the thickness direction is poor. A temperature-equalizing plate of heat transfer design along the thickness direction has excellent heat-conducting performance in the thickness direction; however, the heat-conducting effect in the length direction is poor. Such a temperature-equalizing plate structure can improve the temperature-equalizing effect in one direction and realize temperature equalization within a plane, thus improving the temperature equalization and heat dissipation effect of electronic devices.

However, in certain application scenarios, such as in square energy-storage lithium battery packs, under the premise of ensuring temperature equalization within a large surface of a square lithium battery, if the heat dissipation effect in a direction perpendicular to the large surface of the battery is poor, the heat dissipation effect of the battery cell will also be limited.

Some embodiments of the present disclosure provide a temperature-equalizing plate including a first heat-conducting layer, a second heat-conducting layer, and a third heat-conducting layer. The first heat-conducting layer comprises a first surface and a second surface opposite to each other in a first direction. The second heat-conducting layer comprises a third surface and a fourth surface opposite to each other in the first direction. The third heat-conducting layer is disposed between the first heat-conducting layer and the second heat-conducting layer in the first direction, and comprises a fifth surface, a sixth surface, a seventh surface, and an eighth surface connected in turn, the fifth surface is in abutment with the second surface, and the seventh surface is in abutment with the fourth surface. When the first surface and the third surface are heated, a heat transfer direction of the first heat-conducting layer is from the first surface toward the second surface and further transmitted to the fifth surface, and a heat transfer direction of the second heat-conducting layer is from the third surface toward the fourth surface and further transmitted to the seventh surface.

The present disclosure also provides a battery pack including a plurality of unit batteries and the temperature-equalizing plate as described above, the temperature-equalizing plate is disposed between the unit batteries in a thickness direction of the unit batteries, the first surface and the third surface are in contact with the unit batteries, respectively.

With the disclosed design, the temperature-equalizing plate can absorb heat from both sides of the temperature-equalizing plate through the first heat-conducting layer and the second heat-conducting layer, and transfer heat from one end to the other end through the third heat-conducting layer. Therefore, good heat dissipation can be realized in both the thickness direction and the length direction of the temperature-equalizing plate, thus improving the heat dissipation effect of the temperature-equalizing plate.

### BRIEF DESCRIPTION OF DRAWINGS

The accompanying drawings, which are incorporated in and constitute a part of this specification, illustrate embodiments consistent with the present disclosure and, together with the description, serve to explain the principles of the disclosure.

FIG. 1 is a schematic structural diagram of an exemplary first embodiment of the temperature-equalizing plate of the present disclosure.

FIG. 2 is an exploded schematic structural diagram of the exemplary temperature-equalizing plate shown in FIG. 1.

FIG. 3 is a schematic diagram of heat transfer of an exemplary temperature-equalizing plate according to an embodiment of the present disclosure.

FIG. 4 is a schematic diagram of an internal structure of an exemplary temperature-equalizing plate according to an embodiment of the present disclosure.

FIG. 5 is a schematic structural diagram of an exemplary second embodiment of the temperature-equalizing plate of the present disclosure.

In the Drawings:
100 – temperature-equalizing plate;
200 – battery cell;
300 – elastic member;
1000 – battery module;
10 – first heat-conducting layer;
20 – second heat-conducting layer;
30 – third heat-conducting layer;
40 – liquid cooling plate;
50 – second liquid cooling plate;
101 – first surface;
102 – second surface;
201 – third surface;
202 – fourth surface;
301 – fifth surface;
302 – sixth surface;
303 – seventh surface;
304 – eighth surface;
11 – first frame body;
12 – first wick;
13 – second wick;
14 – first heat-conducting member;
21 – second frame body;
22 – third wick;
23 – fourth wick;
24 – second heat-conducting member;
31 – third frame body;
32 – fifth wick;
33 – third heat-conducting member.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented.

An exemplary embodiment of the present disclosure provides a temperature-equalizing plate. The temperature-equalizing plate can be applied to energy storage batteries, power batteries, and the like, for dissipating heat for the batteries thus achieving temperature uniformity and heat dissipation for the batteries.

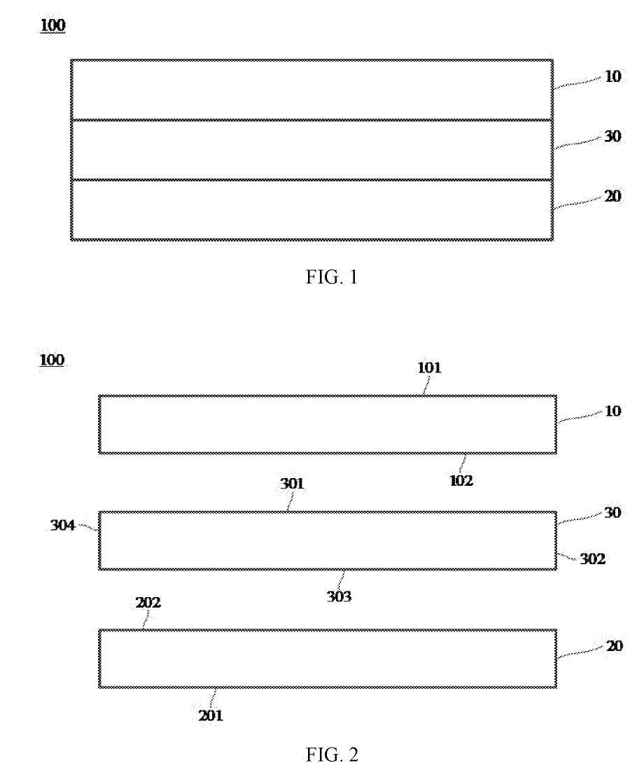

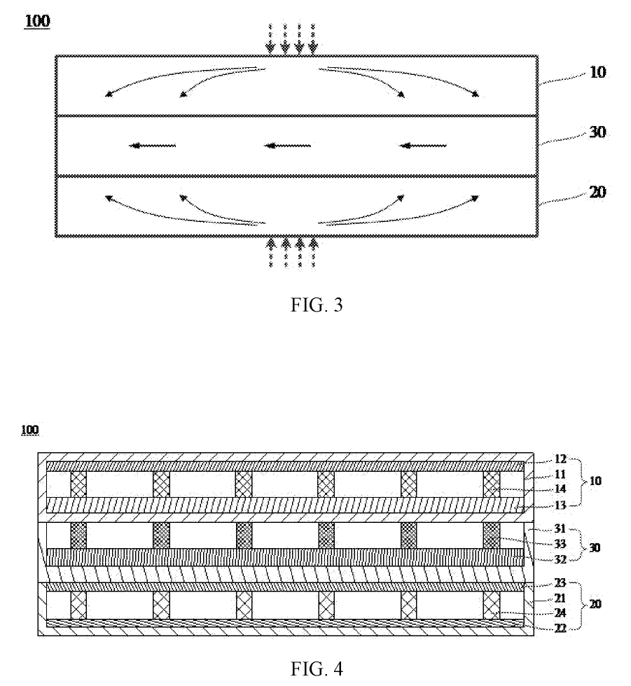

Referring to FIGS. 1–3, FIG. 1 is a schematic structural diagram of an exemplary first embodiment of the temperature-equalizing plate 100 of the present disclosure, FIG. 2 is an exploded schematic structural diagram of the temperature-equalizing plate 100 shown in FIGS. 1, and 3 is a schematic diagram of heat transfer of the temperature-equalizing plate 100 according to an exemplary embodiment of the present disclosure.

The temperature-equalizing plate 100 comprises a first heat-conducting layer 10, a second heat-conducting layer 20, and a third heat-conducting layer 30, the first heat-conducting layer 10, the second heat-conducting layer 20, and the third heat-conducting layer 30 are stacked in a first direction. The second heat-conducting layer 20 is disposed opposite to and spaced apart from the first heat-conducting layer 10. The third heat-conducting layer 30 is disposed between the first heat-conducting layer 10 and the second heat-conducting layer 20.

In particular, the first heat-conducting layer 10 comprises a first surface 101 and a second surface 102 opposite to each other in the first direction. In some embodiments, the first surface 101 is a surface for absorbing heat. As shown by the dashed arrows on one side of the first heat-conducting layer 10 in FIG. 3, a heat transfer direction of the first heat-conducting layer 10 is from the first surface 101 toward the second surface 102.

The second heat-conducting layer 20 comprises a third surface 201 and a fourth surface 202 opposite to each other in the first direction. The fourth surface 202 is disposed opposite to and spaced apart from the second surface 102. In some embodiments, the third surface 201 is a surface for absorbing heat. As shown by the dashed arrows on one side of the second heat-conducting layer 20 in FIG. 3, a heat transfer direction of the second heat-conducting layer 20 is from the third surface 201 toward the fourth surface 202.

The third heat-conducting layer 30 is disposed between the first heat-conducting layer 10 and the second heat-conducting layer 20. The third heat-conducting layer 30 comprises a fifth surface 301, a sixth surface 302, a seventh surface 303, and an eighth surface 304 connected in turn. The fifth surface 301 is in abutment with the second surface 102. The seventh surface 303 is in abutment with the fourth surface 202.

In some embodiments, heat of the first heat-conducting layer 10 can be transferred to the third heat-conducting layer 30, namely, from the second surface 102 to the fifth surface 301, as shown by the solid arrows of the first heat-conducting layer 10 in FIG. 3. Heat of the second heat-conducting layer 20 can be transferred to the third heat-conducting layer 30, namely, from the fourth surface 202 to the seventh surface 303, as shown by the solid arrows of the second heat-conducting layer 20 in FIG. 3. When the sixth surface 302 or the eighth surface 304 is in contact with a liquid cooling plate, heat of the third heat-conducting layer 30 can be transferred from one end to the other end.

The temperature-equalizing plate 100 according to the present disclosure can absorb heat in the first direction through the first heat-conducting layer 10 and the second heat-conducting layer 20, and transfer heat through the third heat-conducting layer 30 from one end to the other end along a direction perpendicular to the first direction. Therefore, good heat dissipation can be realized in both the thickness direction and the length direction of the temperature-equalizing plate 100, thus improving the heat dissipation effect of the temperature-equalizing plate 100.

In some embodiments, a heat transfer direction of the first heat-conducting layer 10 is from a middle portion of the first surface 101 toward a periphery of the second surface 102, as shown by the solid arrows of the first heat-conducting layer 10 in FIG. 3. A heat transfer direction of the second heat-conducting layer 20 is from a middle portion of the third surface 201 toward a periphery of the fourth surface 202, as shown by the solid arrows of the second heat-conducting layer 20 in FIG. 3.

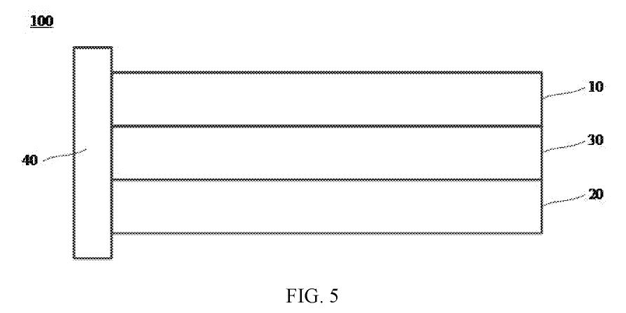

Referring to FIG. 4, FIG. 4 is a schematic diagram of an internal structure of the temperature-equalizing plate 100 according to an exemplary embodiment of the present disclosure. The first heat-conducting layer 10 comprises a first frame body 11, a first wick 12, a second wick 13, and a plurality of first heat-conducting members 14.

In some embodiments, a first cavity containing a heat-conducting liquid is formed inside the first frame body 11, and the first cavity may be in a vacuum state. A material of the first frame body 11 may be a metal or an alloy material such as copper or aluminum having good heat-conducting efficiency. The first surface 101 and the second surface 102 of the first heat-conducting layer 10 are located at opposite sides of the first frame body 11.

The first wick 12 is disposed in the first frame body 11 and is located adjacent to the first surface 101. The second wick 13 is disposed in the first frame body 11 and is located adjacent to the second surface 102. The first wick 12 can absorb the heat-conducting liquid, such that the interior of the first wick 12 contains the heat-conducting liquid, and the first wick 12 may be foam, sponge, or the like. The second wick 13 can absorb the heat-conducting liquid, such that the interior of the second wick 13 contains the heat-conducting liquid, and the second wick 13 may be foam, sponge, or the like. The heat-conducting liquid on the first wick 12 is vaporized by heat absorption and moves to the second wick 13 for heat release and liquefaction. The plurality of first heat-conducting members 14 are disposed at intervals between the first wick 12 and the second wick 13. In some embodiments, a material of the first heat-conducting members 14 may be a metal or an alloy material such as copper having good heat-conducting efficiency. The first heat-conducting members 14 are of a columnar structure and guide the heat-conducting liquid flowing from the second surface 102 toward the first surface 101 after liquefaction.

In some embodiments, the first heat-conducting members 14 may be of a cylindrical shape or a square column shape. A plurality of nanopores are formed inside the first heat-conducting members 14 to enhance capillary action and accelerate movement of the heat-conducting liquid on the first heat-conducting members 14.

In another embodiment, each of the plurality of the first heat-conducting members 14 is of a plate-shaped structure and spans across the first frame body 11. In this way, the first heat-conducting members 14 have stronger support for the first frame body 11. A plurality of through holes mutually spaced are provided in the first heat-conducting members 14, such that the heat-conducting liquid flows through the through holes between adjacent first heat-conducting members 14 to improve fluidity of the heat-conducting liquid.

In some embodiments, a spacing between the first surface 101 and the third surface 201 is H1, where 0.4 mm ≤ H1 ≤ 5 mm, for example, 0.4 mm, 1 mm, 1.5 mm, 2 mm, 2.6 mm, 3 mm, 3.5 mm, 4 mm, 4.3 mm, 4.8 mm, 5 mm, and the like. H1 is a thickness of the temperature-equalizing plate in the first direction. When the temperature-equalizing plate is too thin, its compressive strength is insufficient to withstand pressure generated when the unit batteries expand. When the temperature-equalizing plate is too thick, it occupies too much volume of the unit batteries, thus affecting a volumetric energy density of the battery pack.

In some embodiments, a spacing between the first wick 12 and the second wick 13 is H2. A space between the first wick 12 and the second wick 13 is provided for flow of vaporized heat-absorbing liquid, where 0.1 mm ≤ H2 ≤ 0.2 mm, for example, 0.1 mm, 0.12 mm, 0.14 mm, 0.16 mm, 0.18 mm, 0.2 mm, and the like. When the spacing between the first wick 12 and the second wick 13 is too large, thermal resistance of the temperature-equalizing plate increases greatly, thus affecting heat-conducting efficiency of the temperature-equalizing plate. When the spacing between the first wick 12 and the second wick 13 is too small, a movement distance of the vaporized heat-absorbing liquid is greatly shortened, which is not conducive to liquefaction of the vaporized heat-absorbing liquid.

In some embodiments, a thickness D1 of the first wick 12 is 0.1 mm ≤ D1 ≤ 1.5 mm, for example, 0.1 mm, 0.3 mm, 0.5 mm, 0.7 mm, 0.8 mm, 1.0 mm, 1.2 mm, 1.4 mm, 1.5 mm, and the like. When the thickness of the first wick 12 is greater than this range, the vaporized heat-absorbing liquid is not easily volatilized, and the liquefied heat-absorbing liquid is not easily guided along the first heat-conducting members 14. When the thickness of the first wick 12 is less than this range, an amount of heat-absorbing liquid stored in the first wick 12 is insufficient. Additionally or alternatively, a thickness D2 of the second wick 13 is 0.1 mm ≤ D2 ≤ 1.5 mm, for example, 0.1 mm, 0.3 mm, 0.5 mm, 0.7 mm, 0.8 mm, 1.0 mm, 1.2 mm, 1.4 mm, 1.5 mm, and the like. When the thickness of the second wick 13 is greater than this range, the vaporized heat-absorbing liquid is not easily volatilized, and the liquefied heat-absorbing liquid is not easily guided along the first heat-conducting members 14. When the thickness of the second wick 13 is less than this range, an amount of heat-absorbing liquid stored in the second wick 13 is insufficient.

In some embodiments, a spacing L1 between the first heat-conducting members 14 is 0.05 mm ≤ L1 ≤ 0.5 mm, for example, 0.05 mm, 0.08 mm, 0.1 mm, 0.15 mm, 0.2 mm, 0.25 mm, 0.3 mm, 0.35 mm, 0.4 mm, 0.45 mm, 0.5 mm, and the like. When the spacing of the first heat-conducting members 14 is greater than 0.5 mm, the strength of the temperature-equalizing plate is insufficient. When the spacing of the first heat-conducting members 14 is less than 0.05 mm, it is not conducive to flow of the heat-absorbing liquid between the first heat-conducting members 14.

In some embodiments, the first cavity comprises a middle cavity and an edge cavity, the middle cavity and the edge cavity are in communication with each other, the edge cavity is located at an outer periphery of the middle cavity, a ratio α of the volume of the edge cavity to the volume of the middle cavity is 1 ≤ α ≤ 2, a spacing L2 of the first heat-conducting members 14 located in the middle cavity, and a spacing L1 of the first heat-conducting members 14 located in the edge cavity meet 1.1 ≤ L2/L1 ≤ 5, for example, 1.1, 1.5, 2, 2.5, 3, 3.5, 4, 4.5, 5, and the like. In this embodiment, a density of the first heat-conducting members 14 located in the middle cavity is greater than that of the first heat-conducting members 14 located in the edge cavity, thus locally enhancing a compression resistance of the temperature-equalizing plate in a middle region thereof.

The second heat-conducting layer 20 comprises a second frame body 21, a third wick 22, a fourth wick 23, and a plurality of second heat-conducting members 24.

In some embodiments, a second cavity containing a heat-conducting liquid is formed inside the second frame body 21, and the second cavity may be in a vacuum state, as shown in FIG. 4. A material of the second frame body 21 may be a metal or an alloy material with good heat-conducting efficiency, such as copper or aluminum. The third surface 201 and the fourth surface 202 of the second heat-conducting layer 20 are located at opposite sides of the second frame body 21.

The third wick 22 is disposed in the second frame body 21 and located adjacent to the third surface 201. The fourth wick 23 is disposed in the second frame body 21 and located adjacent to the fourth surface 202. The interior of the third wick 22 contains a heat-conducting liquid and is capable of absorbing the heat-conducting liquid, and the third wick 22 may be foam, sponge, or the like. The interior of the fourth wick 23 contains a heat-conducting liquid and is capable of absorbing the heat-conducting liquid, and the fourth wick 23 may be foam, sponge, or the like. The heat-conducting liquid on the third wick 22 absorbs heat and vaporizes, moves to the fourth wick 23, and releases heat to be liquefied. A plurality of second heat-conducting members 24 are disposed at intervals between the third wick 22 and the fourth wick 23. In some embodiments, a material of the second heat-conducting members 24 may be a metal or an alloy material with good heat-conducting efficiency, such as copper. The second heat-conducting members 24 are of a columnar structure and serve to guide the heat-conducting liquid flowing from the third surface 201 toward the fourth surface 202 after liquefaction.

In some embodiments, the second heat-conducting members 24 may be of a cylindrical shape or a square column shape. A plurality of nanopores are formed inside the second heat-conducting members 24 to improve capillary action and accelerate movement of the heat-conducting liquid on the second heat-conducting members 24.

In another embodiment, the second heat-conducting members 24 are of a plate-shaped structure and span across the second frame body 21. In this way, the second heat-conducting members 24 have a stronger supporting effect on the second frame body 21. The second heat-conducting members 24 are provided with a plurality of through holes mutually spaced, and the heat-conducting liquid flows through the through holes between adjacent second heat-conducting members 24 to improve the fluidity of the heat-conducting liquid.

In some embodiments, a spacing H2 between the third wick 22 and the fourth wick 23 is provided, and a space between the third wick 22 and the fourth wick 23 is configured for a flow of vaporized heat-absorbing liquid, where 0.1 mm ≤ H3 ≤ 0.2 mm, for example, 0.1 mm, 0.12 mm, 0.14 mm, 0.16 mm, 0.18 mm, 0.2 mm, and the like. When the spacing between the third wick 22 and the fourth wick 23 is excessively large, a thermal resistance of the temperature-equalizing plate is greatly increased, thus affecting a heat-conducting efficiency of the temperature-equalizing plate; when the spacing between the third wick 22 and the fourth wick 23 is excessively small, a movement distance of the heat-absorbing liquid vapor is greatly reduced, which is unfavorable for condensation of the vaporized heat-absorbing liquid.

In some embodiments, a thickness D3 of the third wick 22 is 0.1 mm ≤ D3 ≤ 1.5 mm, for example, 0.1 mm, 0.3 mm, 0.5 mm, 0.7 mm, 0.8 mm, 1.0 mm, 1.2 mm, 1.4 mm, 1.5 mm, and the like. When the thickness of the third wick 22 is greater than this range, vaporized heat-absorbing liquid is not easily volatilized, and liquefied heat-absorbing liquid is not easily guided to flow along the second heat-conducting members 24; when the thickness of the third wick 22 is smaller than this range, an amount of heat-absorbing liquid stored in the third wick 22 is insufficient.

In some embodiments, a spacing L3 of the second heat-conducting members 24 is 0.05 mm ≤ L3 ≤ 0.5 mm, for example, 0.05 mm, 0.08 mm, 0.1 mm, 0.15 mm, 0.2 mm, 0.25 mm, 0.3 mm, 0.35 mm, 0.4 mm, 0.45 mm, 0.5 mm, and the like. When the spacing of the second heat-conducting members 24 is greater than 0.5 mm, a strength of the temperature-equalizing plate is insufficient; when the spacing of the second heat-conducting members 24 is smaller than 0.05 mm, it is unfavorable for the flow of the heat-absorbing liquid between the second heat-conducting members 24.

In some embodiments, the second cavity comprises a second middle cavity and a second edge cavity, the second middle cavity and the second edge cavity are in communication with each other, the second edge cavity is located at an outer periphery of the second middle cavity, a ratio α of a volume of the second edge cavity to a volume of the second middle cavity is 1 ≤ α ≤ 2, a spacing L2 of the second heat-conducting members 24 located in the second middle cavity, and a spacing L1 of the second heat-conducting members 24 located in the edge cavity meet 1.1 ≤ L2/L1 ≤ 5, for example, 1.1, 1.5, 2, 2.5, 3, 3.5, 4, 4.5, 5, and the like. In this embodiment, a density of the second heat-conducting members 24 located in the middle cavity is greater than that of the second heat-conducting members 24 located in the edge cavity, thus locally enhancing a compression resistance of the temperature-equalizing plate in a middle region thereof.

In some embodiments, the third heat-conducting layer 30 comprises a third frame body 31, a fifth wick 32, and a plurality of third heat-conducting members 33.

In some embodiments, a third cavity containing a heat-conducting liquid is formed inside the third frame body 31, and the third cavity may be in a vacuum state, as shown in FIG. 4. A material of the third frame body 31 may be a metal or an alloy material with good heat-conducting efficiency, such as copper or aluminum. The fifth surface 301, the sixth surface 302, the seventh surface 303, and the eighth surface 304 of the third heat-conducting layer 30 are located at the third frame body 31.

The fifth wick 32 is disposed in the third frame body 31. The fifth wick 32 contains a heat-conducting liquid. A plurality of nanopores are formed inside the third heat-conducting members 33. In some embodiments, a material of the third heat-conducting members 33 may be a metal or an alloy material with good heat-conducting efficiency, such as copper.

Specifically, the fifth wick 32 is located adjacent to the fifth surface 301, i.e., adjacent to the first heat-conducting layer 10. The plurality of third heat-conducting members 33 are disposed at intervals on a side of the fifth wick 32 opposite to the fifth surface 301, i.e., a side of the fifth wick 32 facing the second heat-conducting layer 20. Alternatively, the fifth wick 32 is located adjacent to the seventh surface 303, i.e., adjacent to the second heat-conducting layer 20. The plurality of third heat-conducting members 33 are disposed at intervals on a side of the fifth wick 32 opposite to the seventh surface 303, i.e., a side of the fifth wick 32 facing the first heat-conducting layer 10, as shown in FIG. 4.

The present disclosure also provides a battery pack including a plurality of unit batteries and the temperature-equalizing plate as described above. The temperature-equalizing plate is disposed between the unit batteries in a thickness direction of the unit batteries, i.e., the temperature-equalizing plate is disposed between the largest side surfaces of the unit batteries, and the first surface 101 and the third surface 201 are respectively in contact with the unit batteries to absorb heat from the unit batteries.

In some embodiments, referring to FIG. 5, FIG. 5 is a schematic structural diagram of an exemplary second embodiment of the temperature-equalizing plate 100 according to an embodiment of the present disclosure.

The temperature-equalizing plate 100 further comprises a liquid cooling plate 40. The liquid cooling plate 40 is disposed on at least one of the sixth surface 302 and the eighth surface 304 of the third heat-conducting layer 30. The liquid cooling plate 40 in FIG. 5 is in abutment with the eighth surface 304. Heat of the eighth surface 304 is transferred to the liquid cooling plate 40. The liquid cooling plate 40 may dissipate heat through liquid inside thereof. Therefore, by disposing the liquid cooling plate 40 in abutment with the eighth surface 304, heat of the third heat-conducting layer 30 may be quickly removed through the liquid cooling plate 40, thus improving the overall heat dissipation of the temperature-equalizing plate 100.

1. A temperature-equalizing plate, comprising:
a first heat-conducting layer comprising a first surface and a second surface opposite to each other in a first direction;
a second heat-conducting layer comprising a third surface and a fourth surface opposite to each other in the first direction; and
a third heat-conducting layer disposed between the first heat-conducting layer and the second heat-conducting layer in the first direction, the third heat-conducting layer comprising a fifth surface, a sixth surface, a seventh surface, and an eighth surface connected in turn, wherein the fifth surface is in abutment with the second surface, and the seventh surface is in abutment with the fourth surface,
wherein upon heating the first surface and the third surface, heat of the first heat-conducting layer is transferred from the first surface toward the second surface and further to the fifth surface, and heat of the second heat-conducting layer is transferred from the third surface toward the fourth surface and further to the seventh surface.

2. The temperature-equalizing plate of claim 1, wherein the first heat-conducting layer comprises:
a first frame body, wherein the first surface and the second surface are located at opposite sides of the first frame body, wherein a first cavity containing a heat-conducting liquid is formed inside the first frame body;
a first wick disposed in the first frame body and located adjacent to the first surface;
a second wick disposed in the first frame body and located adjacent to the second surface; and
a plurality of first heat-conducting members disposed at intervals between the first wick and the second wick.

3. The temperature-equalizing plate of claim 2, wherein a material of the first frame body is copper or aluminum.

4. The temperature-equalizing plate of claim 2, wherein the first wick is foam or sponge; and the second wick is foam or sponge.

5. The temperature-equalizing plate of claim 2, wherein
each of the plurality of first heat-conducting members is of a columnar structure and comprises nanopores, or
each of the plurality of the first heat-conducting members is of a plate-shaped structure, spans across the first frame body, and comprises a plurality of through holes mutually spaced.

6. The temperature-equalizing plate of claim 5, wherein each of the plurality of the first heat-conducting members is of a cylindrical shape or a square column shape.

7. The temperature-equalizing plate of claim 2, wherein a spacing between the first surface and the third surface is H1, wherein 0.4 mm ≤ H1 ≤ 5 mm.

8. The temperature-equalizing plate of claim 2, wherein a spacing between the first wick and the second wick is H2, wherein 0.1 mm ≤ H2 ≤ 0.2 mm.

9. The temperature-equalizing plate of claim 2, wherein a thickness D1 of the first wick is 0.1 mm ≤ D1 ≤ 1.5 mm; or, a thickness D2 of the second wick satisfies 0.1 mm ≤ D2 ≤ 1.5 mm.

10. The temperature-equalizing plate of claim 2, wherein a spacing L1 between the first heat-conducting members satisfies 0.05 mm ≤ L1 ≤ 0.5 mm.

11. The temperature-equalizing plate of claim 10,
wherein the first cavity comprises a middle cavity and an edge cavity,
wherein the edge cavity is located at an outer periphery of the middle cavity,
wherein a ratio α of the volume of the edge cavity to the volume of the middle cavity satisfies 1 ≤ α ≤ 2,
wherein a spacing L2 between the first heat-conducting members located in the middle cavity and a spacing L1 between the first heat-conducting members located in the edge cavity satisfy 1.1 ≤ L2/L1 ≤ 5.

12. The temperature-equalizing plate of claim 1, wherein the second heat-conducting layer comprises:
a second frame body, wherein the third surface and the fourth surface are located at opposite sides of the second frame body, a second cavity containing a heat-conducting liquid is formed inside the second frame body;
a third wick disposed in the second frame body and located adjacent to the third surface;
a fourth wick disposed in the second frame body and located adjacent to the fourth surface; and
a plurality of second heat-conducting members disposed at intervals between the third wick and the fourth wick.

13. The temperature-equalizing plate of claim 12, wherein the second cavity is in a vacuum state.

14. The temperature-equalizing plate of claim 12, wherein a material of the second frame body is copper or aluminum.

15. The temperature-equalizing plate of claim 12, wherein the third wick is foam or sponge, and the fourth wick is foam or sponge.

16. The temperature-equalizing plate of claim 12, wherein each of the plurality of the second heat-conducting members is of a cylindrical shape or a square column shape.

17. The temperature-equalizing plate of claim 1, wherein the third heat-conducting layer comprises:
a third frame body, wherein the fifth surface, the sixth surface, the seventh surface, and the eighth surface are located at the third frame body;
a fifth wick disposed in the third frame body and located adjacent to the fifth surface or the seventh surface; and
a plurality of third heat-conducting members disposed at intervals on the fifth wick;
wherein, when the fifth wick is located adjacent to the fifth surface, the plurality of third heat-conducting members are disposed at intervals on a side of the fifth wick opposite to the fifth surface; or when the fifth wick is located adjacent to the seventh surface, the plurality of third heat-conducting members are disposed at intervals on a side of the fifth wick opposite to the seventh surface.

18. The temperature-equalizing plate of claim 17, wherein the third cavity is in a vacuum state, and a material of the third frame body is copper or aluminum.

19. A battery pack, comprising:
a plurality of unit batteries; and
a temperature-equalizing plate, comprising:
a first heat-conducting layer comprising a first surface and a second surface opposite to each other in a first direction;
a second heat-conducting layer comprising a third surface and a fourth surface opposite to each other in the first direction; and
a third heat-conducting layer disposed between the first heat-conducting layer and the second heat-conducting layer in the first direction, the third heat-conducting layer comprising a fifth surface, a sixth surface, a seventh surface, and an eighth surface connected in turn, wherein the fifth surface is in abutment with the second surface, and the seventh surface is in abutment with the fourth surface;
wherein upon heating the first surface and the third surface, heat of the first heat-conducting layer is transferred from the first surface toward the second surface and further to the fifth surface, and heat of the second heat-conducting layer is transferred from the third surface toward the fourth surface and further to the seventh surface,
wherein the temperature-equalizing plate is disposed between the plurality of unit batteries in a thickness direction of the plurality of unit batteries, the first surface and the third surface are in contact with the plurality of unit batteries, respectively.

20. The battery pack of claim 19, wherein the temperature-equalizing plate further comprises a liquid cooling plate, wherein the liquid cooling plate is in contact with at least one of the sixth surface or the eighth surface.
